(19) United States
(12) Patent Application Publication
(10) Pub. No.: US 2017/0326751 A1
(43) Pub. Date: Nov. 16, 2017

(54) LIQUID JET CUTTING METHOD

(71) Applicant: Robert Bosch GmbH, Stuttgart (DE)

(72) Inventors: Malte Bickelhaupt, Stuttgart (DE); Jens-Peter Nagel, Marbach (DE); Uwe Iben, Khimki (RU)

(21) Appl. No.: 15/535,776

(22) PCT Filed: Oct. 27, 2015
(86) PCT No.: PCT/EP2015/074889

§ 371 Date: Jun. 14, 2017

(30) Foreign Application Priority Data
Dec. 15, 2014 (DE) 10 2014 225 904.5

(51) Int. Cl. B26F 3/00; B24C 1/04

(52) U.S. Cl. CPC B26F 3/004; B24C 1/045

(57) ABSTRACT

The invention relates to a liquid jet cutting method using a compressor unit (3) that comprises a liquid for generating a liquid jet and using a nozzle (10) that is connected to the compressor unit (3) and has an outlet opening (11) through which the compressed liquid exits in the form of a liquid jet (14). The flow of the compressed liquid to the outlet opening (11) can be interrupted or released by means of an interruption unit (8). The method has the following steps: compressing the liquid by means of the compressor unit (3), moving the outlet opening (11) closer to a workpiece (15) to be machined up to a machining distance (d), and alternatively releasing and interrupting the liquid jet (14) by means of the interruption unit (8), wherein the nozzle is simultaneously moved relative to the workpiece in a machining direction (22), and the machining angle between the workpiece surface (115) and the liquid jet (14) is less than 90°.

### BACKGROUND OF THE INVENTION

The present invention relates to a liquid jet cutting method, as is preferably used to cut up solid materials.

Methods for liquid jet cutting of solid materials have been known from the prior art for a relatively long time. Here, water is preferably compressed by way of a compressor unit to a very high pressure which is usually several thousand bar. The liquid subsequently flows through a nozzle, exits through an outlet opening and, as a result, forms a liquid jet which is directed onto the material to be cut up. On account of the high speed and the high pulse of the water, the water jet smashes the material in the region of the liquid jet and cuts it up as a result. Solid materials can be machined by way of said method, for example metal, glass, plastic, wood and similar materials. Since the compression of the water requires a large amount of energy and the liquid jet or the water jet is operated continuously, said material machining is possible only with a high power consumption which can be several tens of kilowatts in the customary known systems. The operating costs of a system of this type are correspondingly high.

In order to improve the action of the water jet, it is likewise known to mix abrasive materials into the water jet, which abrasive materials are entrained by the water and strike the workpiece surface with high energy and thus improve the action of the water jet. However, the costs are increased further as a result of the addition of the abrasive materials, and the used water can no longer be simply returned into the circuit, since the abrasive materials first of all have to be filtered out in a complicated method.

DE 10 2013 201 797 A1 has disclosed an apparatus for liquid jet cutting, which apparatus does not use a continuous water jet for cutting up the material, but rather a pulsed water jet, in the case of which the liquid jet is interrupted at regular intervals. The pulsed liquid jet has the advantage, in particular, that the cutting device manages with a relatively low pressure and, above all, is considerably more energy-efficient than the known constant jet cutting methods. The operating parameters are of decisive significance, however, for an optimum action of the liquid jet cutting.

### SUMMARY OF THE INVENTION

In contrast, the liquid jet cutting method according to the invention has the advantage that an efficient and energy-saving cutting method is ensured, which additionally leads to an improved cut edge, with the result that particularly smooth cut edges can be achieved. To this end, the liquid jet cutting method has a compressor unit which compresses a liquid for producing a liquid jet, and a nozzle which is connected to the compressor unit. The nozzle has an outlet opening, through which the compressed liquid exits in the form of a liquid jet, and with an interrupter unit which can interrupt or release a flow of the compressed liquid to the outlet opening. Here, the following method steps are carried out: the liquid is compressed by way of the compressor unit, the outlet opening is moved up to the workpiece to be machined as far as a machining distance, the liquid jet is released and interrupted in an alternating manner by way of the interrupter unit, the nozzle at the same time being moved with respect to the workpiece in a machining direction. Here, the machining angle between the workpiece surface and the liquid jet is less than 90°.

As a result of the smaller machining angle in contrast to the known right angle, the action of the machining can be improved, above all, in the case of relatively hard workpieces. If the liquid jet strikes the workpiece surface at a relatively small machining angle, an edge with an acute machining angle is formed at the end of the cut in the workpiece, on which the liquid jet can act and can thus smash the material in an improved manner, in particular hard materials.

In one advantageous refinement of the invention, the machining angle is more than 60°, preferably from 60° to 80°. Said angular range has proven advantageous, in particular, in the case of very hard materials. It is advantageous here to use a smaller machining angle, the harder the material to be machined is.

In one advantageous refinement of the invention, the pulse duration is from 100 to 1000 μs, the liquid jet advantageously being opened and closed periodically by way of the interrupter unit for producing liquid pulses. If the liquid pulses are produced periodically, the workpiece can be moved at a uniform speed in the machining direction, with the result that a cut line is produced in the workpiece.

In a further advantageous refinement, between 25 and 500 liquid pulses per second are produced, that is to say the liquid pulses are sprayed onto the workpiece at a frequency of from 25 to 500 Hz. The frequency of the liquid pulses is based on the machining speed, that is to say the speed, at which the nozzle moves relative to the workpiece, and on the thickness and the material properties of the workpiece.

In a further advantageous refinement, the spacing of the nozzle opening from the workpiece surface during the machining is from 0.5 to 2 mm, preferably from 1 to 2 mm. Said spacing ensures efficient machining of the workpiece, without it being possible for the water which sprays back to lead to damage of the nozzle.

In a further advantageous refinement, the nozzle is moved relative to the workpiece at a speed of from 10 to 1200 mm per minute, the advancing speed being dependent on the thickness of the workpiece and the material properties of the workpiece.

In a further advantageous refinement, the nozzle has a nozzle body with a longitudinal bore, the longitudinal bore forming a pressure space, into which the compressed liquid is fed. The interrupter unit is formed by way of a nozzle needle which is arranged longitudinally displaceably within the pressure space and opens and closes the outlet opening by way of its longitudinal movement. Precise liquid pulses can be produced with the desired duration and at the desired frequency by way of said nozzle which is known, for example, from high pressure fuel injection.

### BRIEF DESCRIPTION OF THE DRAWINGS

Further advantages and advantageous refinements can be gathered from the description, the drawing and the claims.

The following is shown in the drawing in order to illustrate the method according to the invention:

FIG. 1 shows a diagrammatic illustration of an apparatus for carrying out the liquid jet cutting method according to the invention,

FIG. 2 shows a likewise diagrammatic illustration of the nozzle for liquid jet cutting,

FIG. 3 shows an enlarged, diagrammatic cross section through the workpiece in the region, in which the liquid jet cuts up the workpiece, and

FIG. 4 shows a diagrammatic illustration of the temporal evolvement of the output liquid quantity of the apparatus.

### DETAILED DESCRIPTION

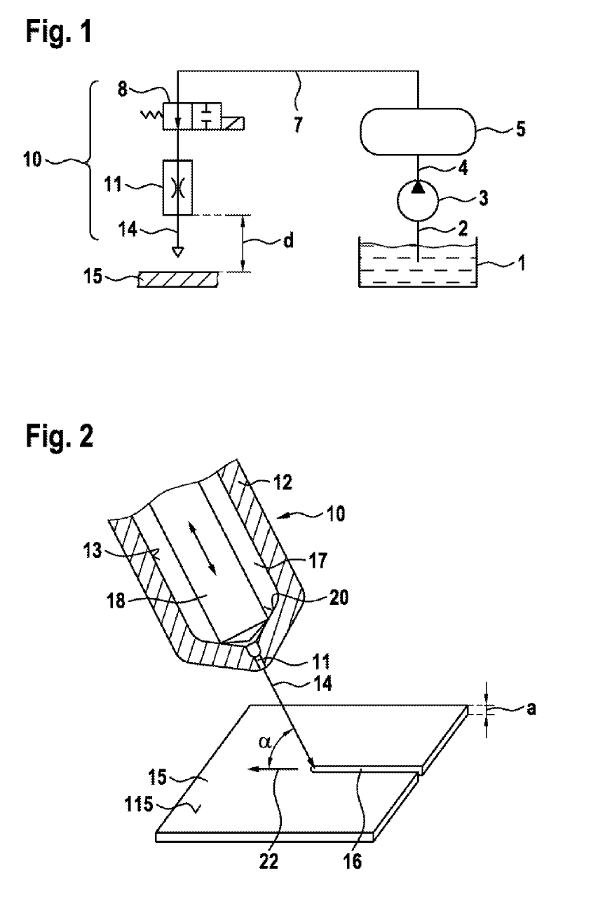

FIG. 1 shows an apparatus for carrying out the liquid jet cutting method according to the invention. The liquid is stored in a tank 1, which liquid is used for liquid jet cutting, for example purified water; other liquids are also possible, however. The liquid is fed out of the liquid tank 1 via a lining 2 to a compressor unit 3, for example a high pressure pump, where the liquid is compressed and is fed via a high pressure line 4 into a high pressure collecting space 5, where the compressed liquid is stored. The high pressure collecting space 5 serves to equalize pressure fluctuations, in order for it thus to be possible to carry out the liquid jet cutting at a constantly high pressure, without it being necessary for the compressor unit 3 to be adjusted at short time intervals. A pressure line 7 leads from the high pressure collecting space 5 to a nozzle 10, the nozzle 10 having an interrupter unit 8 (in the form of a 2/2-way valve here) and an outlet opening 11 in the form of a constricted passage for the liquid, with the result that a liquid jet 14 which is sharply focused and strikes a workpiece 15 during the operation exits from the outlet opening 11.

The method according to the invention is carried out as follows: highly compressed liquid is present via the pressure line 7 in the nozzle 10, the interrupter unit 8 being closed at the beginning. In order to produce a pulsed liquid jet 14, the interrupter unit 8 is then closed and opened at regular intervals, with the result that a pulsed liquid jet 14 exits through the outlet opening 11, which pulsed liquid jet 14 strikes the surface of the workpiece 15. Upon the contact of the liquid on the workpiece 15, the relevant regions are smashed, and the fragments are washed away via the liquid which flows out. The workpiece is cut up as a result, the cut line being produced by way of a movement of the workpiece 15 in a machining direction, it also being possible for provision to be made that it is not the workpiece 15, but rather the nozzle 10 which is moved relative to the workpiece 15 by way of a suitable apparatus.

To this end, FIG. 2 shows a diagrammatic illustration of a nozzle 10 according to the invention with the associated workpiece 15. The nozzle 10 which is shown here has a nozzle body 12, in which a bore 13 is configured, in which a nozzle needle 18 is arranged longitudinally displaceably. A pressure space 17 is configured between the wall of the bore 13 and the nozzle needle 18, into which pressure space 17 the highly compressed liquid is fed via the pressure line 7. The nozzle needle 18 interacts with a nozzle seat 20, with the result that, when the nozzle needle 18 bears against the nozzle seat 20, the pressure space 17 is separated from the injection opening 11 which is configured as a bore in the nozzle body 10. When the nozzle needle 18 lifts up from the nozzle seat 20, liquid flows out of the pressure space 17 through the outlet opening 11 and forms a liquid jet 14 which strikes the workpiece 15.

In order to cut up the workpiece, the nozzle needle 18 is moved up and down periodically and thus releases the liquid jet 14 or interrupts the liquid feed between two injection operations. The workpiece 15 is moved in the machining direction 22, it being unimportant whether the workpiece or the nozzle is moved or even both are moved at the same time.

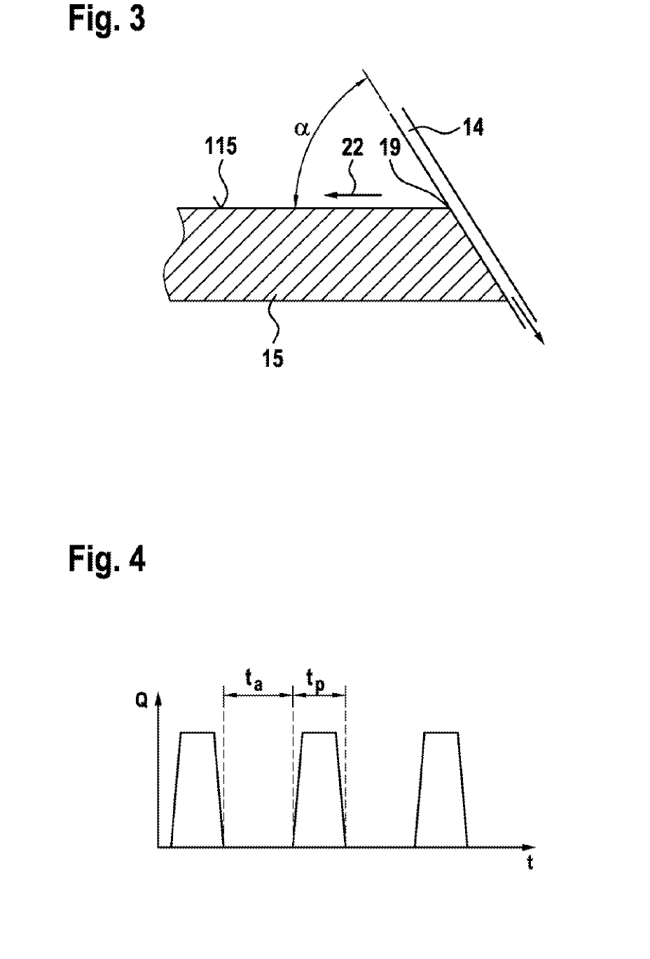

The nozzle body 10 and therefore the liquid jet 14 are inclined at a machining angle α with respect to the workpiece surface 115 of the workpiece 15, the machining angle α being less than 90°. Here, the machining angle α is defined between the liquid jet 14 and the workpiece surface 115 in the machining direction 22. When the liquid jet 14 strikes the workpiece surface 115, the liquid jet 14 smashes the material of the workpiece 15 in said region. The oblique positioning of the liquid jet 14 results in an edge 19 at the end of the cut, which edge 19 encloses an obtuse angle between the workpiece surface 115 and the cut as a result of the liquid jet 14 which, in the ideal case, adds up with the machining angle α to form 180°, as shown on an enlarged scale in FIG. 3 in a longitudinal section through the workpiece 15. The workpiece 15 can be smashed more easily by way of the liquid jet 14 as a result of the acute angle at the edge 19, in particular in the case of very hard materials, and can therefore be cut more easily and with a higher quality.

The harder a material, the better the results which are achieved by way of smaller machining angles α. In the case of relatively soft materials, the machining can also be carried out by way of a relatively great machining angle, with the result that the optimum machining angle can be optimized according to the hardness of the workpiece.

FIG. 4 diagrammatically shows the temporal evolvement of the liquid jet, the discharged liquid quantity per unit time Q being plotted on the ordinate and the time t being plotted on the abscissa. By way of the opening and closing of the interrupter unit 8, a liquid jet 14 is ejected periodically out of the nozzle 10, the individual pulses having a time tₚ and a time interval from one another of tₐ. The pulses can follow one another periodically, as shown here, and can all be of identical configuration, or different pulses can also be produced which follow one another in a regular manner or at variable time intervals.

The duration of the liquid pulses tₚ is less than 1000 μs, preferably from 100 to 1000 μs, in order to achieve an optimum cut edge depending on the material. The pulsed liquid jet cutting is particularly satisfactorily suitable for cutting up fiberglass or carbon fiber plates (CFRP) or metal plates, for example aluminum. Specifically for the machining of CFRP materials, the pulsed liquid jet cutting provides an advantage over constant liquid jet cutting with a considerably smoother cut edge, that is to say the fraying of the carbon fibers at the edge of the cut edge is largely prevented. At the same time, the energy input when cutting up a CFRP plate can be lowered by up to a factor of 20. Moreover, the pulsed water jet cutting manages with a lower pressure. The liquid is stored within the nozzle 12 at a pressure of, for example, 2500 bar, which is considerably reduced in comparison with the otherwise known constant liquid jet cutting methods, which usually operate at up to 6000 bar, with a correspondingly lower energy consumption.

The machining distance of the nozzle 10 from the workpiece 15 (denoted by d in FIG. 1 and FIG. 2) is preferably from 0.5 to 2 mm, preferably from 1 to 2 mm. At said machining distance d, an optimum action is achieved, without it being necessary to expect damage of the nozzle as a result of liquid which sprays back.

The pulsed liquid jet cutting is suitable in the case of CFRP materials, in particular, for plates with a thickness a of up to 2 mm, the diameter of the liquid jet being approximately 150 μm. The pressures which are used are approximately 2500 bar, it also being possible for operation to be carried out with a lower liquid pressure. Optimum machining angles α are from 60° to 80°, cycle rates at a pulse frequency of more than 40 Hz and a pulse duration of 1000 μs or less, it being necessary for the cycle rate to be adapted to the advancing speed of the machining, that is to say the cycle rate must be higher, the more rapid the advancing speed.

The liquid jet is interrupted periodically by means of the interrupter unit in order to achieve the liquid pulses. In the context of this invention, however, the term “interrupt” does not necessarily denote complete closure of the outlet opening at the nozzle. It can also be provided that the interrupter unit merely throttles the liquid jet to a very pronounced extent, but that some liquid at a low pressure still exits between the liquid pulses. The effects which are described are then also achieved, provided that the throttling is sufficiently pronounced. Here, throttling of from 80 to 90% of the liquid quantity which exits from the nozzle 10 in a non-throttled manner per time unit Q is sufficient.

1. A liquid jet cutting method utilizing a compressor unit (3) which compresses a liquid for producing a liquid jet, a nozzle (10) which is connected to the compressor unit (3) and has an outlet opening (11), through which the compressed liquid exits in the form of a liquid jet (14), and an interrupter unit (8) which can interrupt or release a flow of the compressed liquid to the outlet opening (11), the method comprising:
compressing the liquid by way of the compressor unit (3),
moving up the outlet opening (11) to a workpiece (15) to be machined as far as a machining distance (d), and
releasing and interrupting the liquid jet (14) out of the outlet opening (11) in an alternating manner by way of the interrupter unit (8), the nozzle at the same time being moved relative to the workpiece in a machining direction (22),
wherein a machining angle (α) between the workpiece surface (115) and the liquid jet (14) is less than 90°.

2. The method as claimed in claim 1, characterized in that the machining angle (α) is more than 60°.

3. The method as claimed in claim 1, characterized in that the machining angle (α) is varied in a manner which is dependent on a hardness of the workpiece (15).

4. The method as claimed in claim 3, characterized in that the machining angle (α) is selected to be smaller in the case of a harder workpiece (15) and to be larger in the case of a softer workpiece (15).

5. The method as claimed in claim 1, characterized in that the pulse duration (tₚ) of the liquid jet (14) is from 100 to 1000 μs.

6. The method as claimed in claim 1, characterized in that the liquid jet (14) is opened and closed periodically by way of the interrupter unit (8) in order to produce liquid pulses.

7. The method as claimed in claim 6, characterized in that the interrupter unit (8) is arranged in the nozzle (10).

8. The method as claimed in claim 6, characterized in that between 25 and 500 liquid pulses per second are produced.

9. The method as claimed in claim 1, characterized in that the machining distance (d) of the outlet opening (11) from the workpiece surface during the machining is from 0.5 to 2 mm.

10. The method as claimed in claim 1, characterized in that the nozzle (10) is moved during the machining relative to the workpiece surface at an advancing speed of from 10 to 1200 mm per minute.

11. The method as claimed in claim 1, characterized in that the nozzle (10) has a nozzle body (12) with a bore (13), and the bore (13) forms a pressure space (17), into which the compressed liquid is fed, the interrupter unit (8) being formed by way of a nozzle needle (18) which is arranged longitudinally displaceably within the pressure space (17) and opens and closes the outlet opening (11) by way of its longitudinal movement.

12. The method as claimed in claim 1, characterized in that the machining angle (α) is from 60° to 80°.

13. The method as claimed in claim 1, characterized in that the machining distance (d) of the outlet opening (11) from the workpiece surface during the machining is from 1.0 to 2.0 mm.
